(19) United States
(12) Patent Application Publication
(10) Pub. No.: US 2025/0341428 A1
(43) Pub. Date: Nov. 6, 2025

(54) TEMPERATURE ESTIMATION WITH REDUCED COMPUTATIONAL BURDEN

(71) Applicant: Rivian IP Holdings, LLC, Irvine, CA (US)

(72) Inventors: Mehrdad YAZDANIAN, Irvine, CA (US); Younes SANGSEFIDI, Irvine, CA (US); Chia-Chou YEH, Torrance, CA (US); Yo Chan SON, Rancho Palos Verdes, CA (US); Moonhyun LEE, Los Angeles, CA (US); Brendan Christopher ZOTTO, Los Angeles, CA (US)

(21) Appl. No.: 18/655,176

(22) Filed: May 3, 2024

(51) Int. Cl. G01K 1/14; H02P 29/68

(52) U.S. Cl. CPC G01K 1/14; H02P 29/68

(57) ABSTRACT

Temperature of a DC link capacitor coupled to power electronics of an electric vehicle is estimated without a temperature sensor being mounted directly to the DC link capacitor. The power electronics include a microprocessor with a temperature sensor, such as internal to the microprocessor. The power electronics and DC link capacitor are modeled as a simplified electro-thermal model in which all the power electronics, other than the microprocessor are modeled as a single element. State space equations derived from the electro-thermal model are evaluated to obtain an estimated temperature of the DC link capacitor for a given time step.

### INTRODUCTION

The present disclosure relates to estimating the temperature of components in an electrical system, such as a power electronics of an electric vehicle.

### SUMMARY

The present disclosure describes an approach for estimating the temperature of a component, such as a DC link capacitor of power electronics for converting between direct current (DC) and alternating current (AC). In one aspect, an apparatus includes power electronics contained within a housing. The power electronics include circuits configured to convert direct current (DC) current to alternating current (AC) current and supply the AC current to a motor. The power electronics include a microprocessor positioned within the housing and configured to control operation of the power electronics. The microprocessor has a temperature sensor mounted directly thereto; the temperature sensor being configured to sense a temperature of the microprocessor. A DC-link capacitor is coupled to an input of the power electronics. A controller is coupled to the microprocessor and configured to receive outputs of the temperature sensor and receive one or more operational parameters of the power electronics. The controller is further configured to determine an estimated temperature of the DC-link capacitor based on the outputs of the temperature sensor and the one or more operational parameters of the power electronics.

### BRIEF DESCRIPTION OF THE DRAWINGS

FIG. 1A illustrates an example vehicle having that may be operated in accordance with certain embodiments.

FIG. 1B illustrates a chassis of a vehicle having multiple drive units that may be operated in accordance with certain embodiments.

FIG. 2 is a schematic block diagram of components for operating the vehicle in accordance with certain embodiments.

FIG. 3 is schematic block diagram illustrating power electronics of a vehicle in accordance with certain embodiments.

FIG. 4 is a circuit diagram of an electro-thermal model for estimating temperature in accordance with certain embodiments.

FIG. 5 is a process flow diagram of a method for estimating temperature in accordance with certain embodiments.

FIGS. 6A to 6F are plots showing estimated and measured temperatures of a component of the power electronics in accordance with certain embodiments.

### DETAILED DESCRIPTION

A computationally simple estimation of the temperature(s) of one or more components of power electronics of an electric vehicle, such as a direct current (DC) link capacitor, is achieved using temperature measurements from an internal temperature sensor of a microprocessor within the inverter. The temperature measurements provide a reference point enabling a model of the components of the power electronics to be drastically simplified while still achieving sufficient accuracy. In particular, the model includes an element representing the microprocessor, a single element representing remaining components of the power electronics, and an element representing the DC link capacitor.

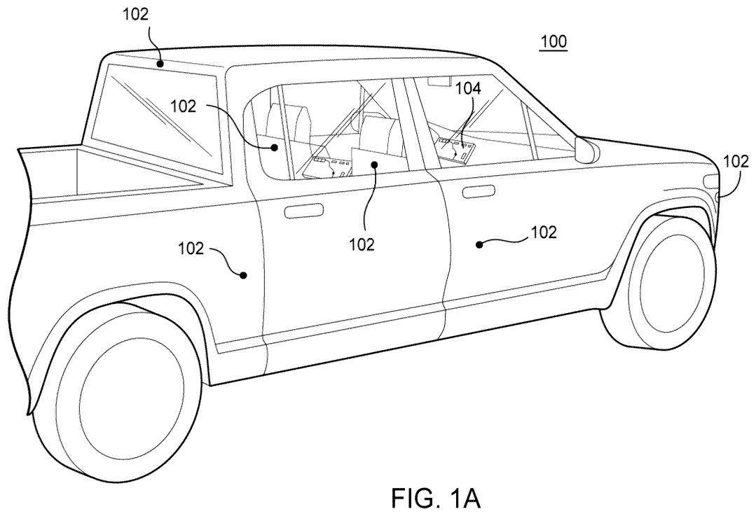

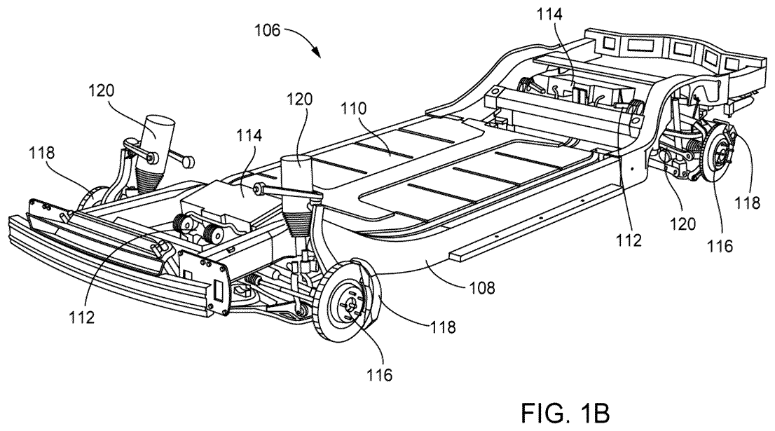

FIG. 1A illustrates an example vehicle 100 in which the approach described herein may be implemented. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial portion (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by one or more sets of power electronics 114, such as power electronics for each drive unit 112 or pair of drive units 112. The power electronics 114 may include inverters configured to convert direct current (DC) from the battery 110 into alternating current (AC) supplied to the motors of the drive units 112. The power electronics 114 further facilitate operation of the motors of the drive units as generators to provide regenerative braking. The power electronics 114 further facilitate the transfer of regenerative current to the battery 110.

The drive units 112 are coupled to two or more hubs 116 to which wheels may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIGS. 1B and 1n the discussion below, the vehicle 100 is a battery electric vehicle. However, a hybrid-electric vehicle may also benefit from the approach described herein.

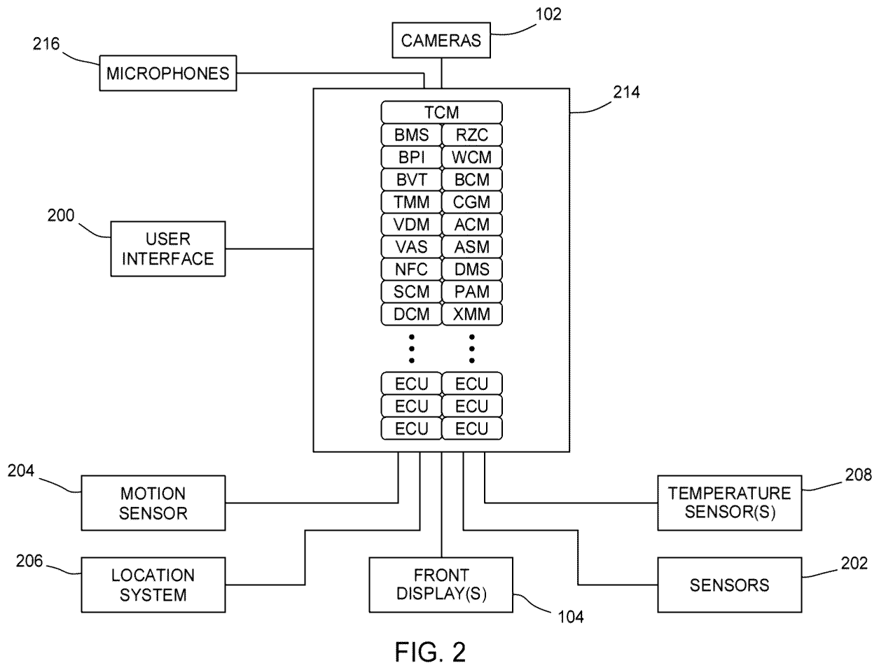

FIG. 2 illustrates example components of the vehicle 100 of FIG. 1A. As seen in FIG. 2, the vehicle 100 includes the cameras 102, the one or more front displays 104, a user interface 200, one or more sensors 202, a motion sensor 204, and a location system 206. The one or more sensors 202 may include ultrasonic sensors, radio detection and ranging (RADAR) sensors, light detection and ranging (LIDAR) sensors, or other types of sensors. The location system 206 may be implemented as a global positioning system (GPS) receiver. The user interface 200 allows a user, such as a driver or passenger in the vehicle 100, to provide input.

The components of the vehicle 100 may include one or more temperature sensors 208. The temperature sensors 208 may include sensors configured to sense an ambient air temperature, temperature of the battery 110, temperature of power electronics 114, temperature of each drive unit 112 and/or each motor of each drive unit 112, temperature of coolant fluid entering or leaving a coolant system, temperature of oil within a drive unit 112, or the temperature of any other component of the vehicle 100. The temperature sensors 208 may include a temperature sensor mounted directly to a microprocessor of the power electronics 114 as described in greater detail below.

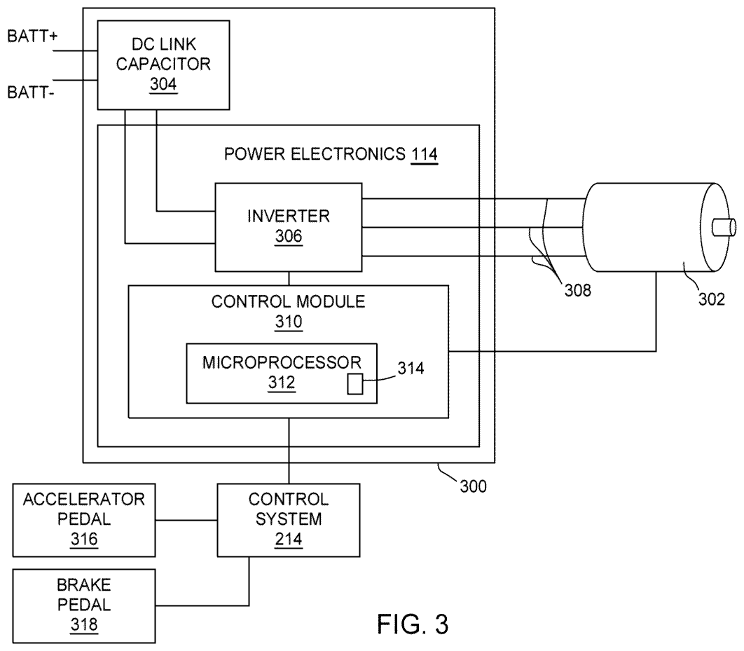

A control system 214 executes instructions to perform at least some of the actions or functions of the vehicle 100. For example, as shown in FIG. 2, the control system 214 may include one or more electronic control units (ECUs) configured to perform at least some of the actions or functions of the vehicle 100, including the functions described in relation to FIGS. 3 to 6. In certain embodiments, each of the ECUs is dedicated to a specific set of functions.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102, sensors 202, motion sensor 204, location system 206, and temperature sensor(s) 208. The sensor signals collected by the CGM ECU are then communicated to the appropriate ECUs for processing.

The control system 214 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU.

If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a Thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 216, etc.) to the TCM ECU.

Referring to FIG. 3, the power electronics 114 may be contained within a housing 300, such as a housing made of aluminum or steel. The power electronics 114 may include a plurality of components configured to convert direct current (DC) from the battery 110 into alternating current (AC), such as three-phase AC, supplied to one or more motors 302 of the drive unit 112 including the power electronics 114. The illustrated components may also be in separate housings that are mounted to one another such that heat transfer occurs and the multiple housings may be modeled as a single thermal system.

The power electronics 114 may receive power from the battery 110 by way of a DC link capacitor 304 that is coupled to the positive and negative terminals (Batt+, Batt−) of the battery 110 and functions to smooth current received from the battery 110 as part of the process by which the direct current from the battery 110 is converted to an approximately sinusoidal alternating current. The DC link capacitor 304 may further function to dampen any voltage spikes. The DC link capacitor 304 may be within the housing 300 or external to the housing 300.

The power electronics may include an inverter 306 coupled to the outputs of the DC link capacitor 304. The inverter 306 may include a plurality of switches that are selectively opened and closed to cause transmission of current to the outputs of the power electronics 114 at an appropriate frequency for driving the one or more motors 302. For example, the inverter 306 may output three-phase current over lines 308 connecting the inverter 306 to the motor 302. The opening and closing of the switches of the inverter 306 may be controlled by a control module 310. The control module 310 may include a printed circuit board with various electronic components configured to generate the control signals for the inverter 306. In some embodiments, the power electronics 114 drive two drive units 112 and include separate printed circuit boards for supplying current to the motors 302 of the separate drive units.

The control module 310 may further include a microprocessor 312 programmed to control operation of the control module 310 and therefore the inverter 306. The microprocessor 312 may be embodied as a silicon chip mounted to the printed circuit board of the control module 310. The microprocessor 312 may include a temperature sensor 314 mounted directly thereto. “Mounted directly” may be understood as being mounted to the microprocessor with no air gap and no intervening insulation (e.g., no intervening material with thermal conductivity less than 0.2 W/m·K). The temperature sensor 314 may be mounted to the microprocessor 312 by being internal to the microprocessor 312 with the microprocessor being configured to read the output of the temperature sensor 314 from an internal register. For example, the temperature sensor 314 may be implemented by structures within the silicon of the microprocessor 312. The temperature sensor 314 may be mounted to the microprocessor by being encased in the packaging of a silicon chip implementing the microprocessor 312, e.g., a metal or plastic covering molded directly over the silicon chip. The temperature sensor 314 may be mounted to the packing of the silicon chip in direct thermal contact, e.g., no insulation or air gap present between the temperature sensor 314 and the packaging. For example, the temperature sensor may be mounted to a metal lid of the silicon chip package. The temperature sensor 314 has the advantage of not requiring a separate part and associated manufacturing, installation, and inventory management costs.

The control module 310 may be coupled to the control system 214 and implement instructions from the control system 214 to control current supplied to the motor 302 and to cause the motor 302 to produce regenerative current. The control system 214 may generate such instructions as part of an automated driving algorithm (e.g., automatic cruise control), safety algorithm (e.g., traction control, stability control, automated emergency braking), or in response to inputs from a driver by way of an accelerator pedal 316 and/or brake pedal 318.

The DC link capacitor 304 and power electronics 114 are subject to parasitic losses (e.g., resistive, switching, capacitive, inductive etc.). The parasitic losses will generally increase with increasing current passing through DC link capacitor 304 and power electronics 114 from the battery 110 to the motor 302 or from the motor 302 to the battery 110. The temperature of the DC link capacitor 304 and power electronics 114 is further a function of the ambient temperature of the environment around the housing 300, a rate of air flow around the housing 300, and the temperature and flow rate of any cooling fluid circulated around the housing 300.

In some embodiments, no other temperature sensor is in thermal contact with the DC link capacitor 304 and power electronics 114. For example, no temperature sensor may be mounted directly to the housing 300 or, where housed individually, no temperature sensor is mounted to an individual housing of the DC link capacitor 304 or a component of the power electronics 114. Other temperature sensors may be present, such as a temperature sensor configured to sense temperature of the motor 302 or a gear train driven by the motor, such as mounted on or within a housing of the drive unit 112 including the motor 302. However, such temperature sensors are not sufficient to sense the temperature of the power electronics 114 or the DC link capacitor 304. For example, there may be no temperature sensor in thermal contact with the power electronics 114. For example, any other temperature sensors mounted to the vehicle 100 at least one of (a) at least 10 cm away from the housing 300 and (b) external to the housing 300 and separated from the housing 300 by an air gap or insulating material at least 3 mm thick (thermal conductivity less than 0.2 W/m·K).

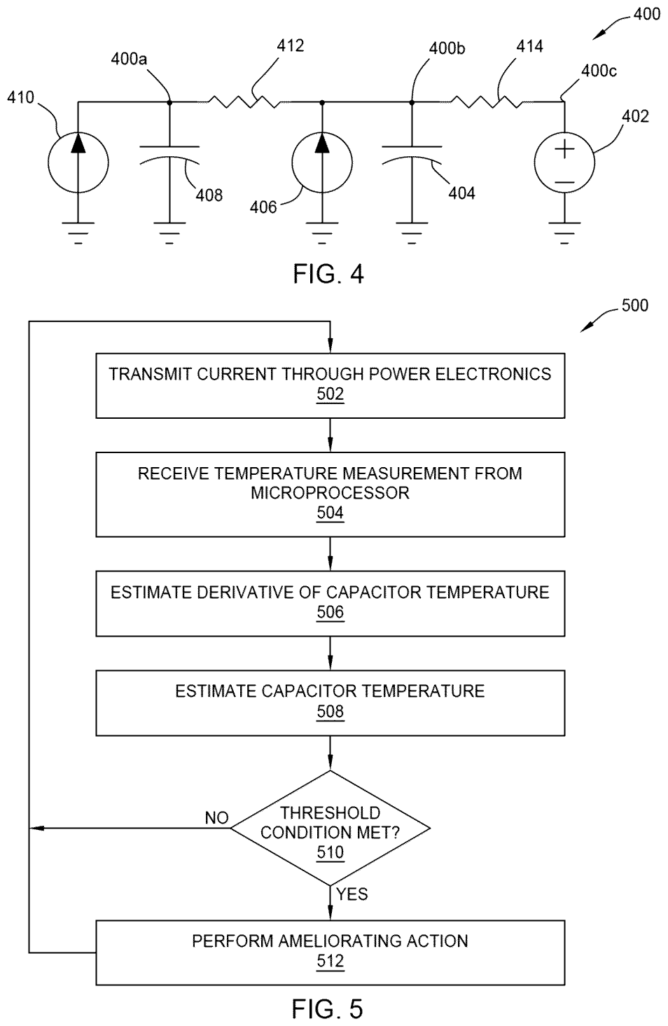

Referring to FIG. 4, the thermal behavior of the DC link capacitor 304 and power electronics 114 may be modeled as the illustrated electro-thermal model 400. The illustrated current and voltage sources, capacitors, and resistors represent thermal analogs of such components. The illustrated electro-thermal model 400 includes three nodes: node 400a representing the temperature of the DC link capacitor 304, node 400b representing the temperature within the housing 300, and node 400c representing the temperature of the microprocessor 312. The temperature represented by node 400a may represent a particular point on the DC link capacitor 304, e.g., a location of peak temperature under typical operation. In some embodiments, the node 400b represents the average temperature of the area surrounding the DC link capacitor 304 and the entirety of losses (e.g., resistive losses) within the power electronics 114 other than the microprocessor 312.

In the electro-thermal model 400, the mass of the microprocessor 312 may be ignored. The microprocessor may be modeled as a voltage source 402 having a known voltage, i.e., a constant source of thermal energy corresponding to the power consumption of the microprocessor 312.

The power electronics 114 other than the microprocessor 312 may further be modeled as a capacitor 404 (e.g., a thermal analog to capacitance) and a current source 406, the current of the current source 406 corresponding to heat generated within the power electronics 114 other than the microprocessor 312.

The DC link capacitor 304 may be modeled as a capacitor 408 and a current source 410, the current of the current source 410 corresponding to heat generated due to parasitic losses. Resistance to heat flow between the DC link capacitor 304 and the rest of the power electronics 114 may be represented as a resistor 412. Resistance to heat flow between the microprocessor 312 and the rest of the power electronics 114 may be represented by a resistor 414.

As shown, voltage source 402 is modeled as being positioned between node 400c and ground, current source 406 is modeled as being positioned between node 400b and ground, and current source 410 is modeled as being positioned between node 400a and ground. Resistor 412 may be modeled as being interposed between node 400a and node 400b and resistor 414 may be modeled as being interposed between node 400b and node 400c.

FIG. 5 illustrates a method 500 for estimating and using a temperature of the DC link capacitor 304. The method 500 may be repeated for each time step n of a plurality of time steps with a period of Δt between time steps. The method 500 includes transmitting, at step 502, current through the power electronics 114, which may include current for driving the motor 302 or regenerative current generated by the motor 302. In either case, the amount of current transmitted during a time step may be measured once for the time step n, or an average of a series of measurements of current for the time step n may be calculated. Measurements of current may be represented as Iₚₕ, which is the magnitude of the phase current passing through the power electronics 114, a phase ϕ of the phase current, and M, which is the modulation index of the phase current (a metric corresponding to torque output of the motor 302).

The method 500 may include receiving, at step 504, a temperature measurement from the microprocessor 312 for the time step n, e.g., from the temperature sensor 314, which temperature is referred to herein as T_{Micro}[n]. T_{Micro}[n] may be the result of a single measurement or the average of multiple temperature measurements for the time step n.

The method 500 includes estimating, at step 506, a derivative of the temperature of the DC link capacitor 304. For example, a series of state space equations representing the electro-thermal model 400 may be evaluated using measurements of temperature (T_{Micro}[n]) and current (Iₚₕ, ϕ, M) and prior values of one or more additional state variables.

For example, the rate of change of the electro-thermal model 400 for a time step n may be represented using equations (1) and (2):

$${\dot{T}}_{Inv} [ n ] = ( 1 - {τ}_{1} ) \times {T}_{Inv} [ n - 1 ] + {τ}_{1} \times {T}_{c a p} [ n - 1 ] + \frac{{T}_{S} [ n - 1 ]}{{C}_{Inv}} \times InvLoss + {τ}_{1} \times ( {T}_{M i c r o} [ n ] - {T}_{Inv} [ n - 1 ] ) \qquad ( 1 )$$

$${\dot{T}}_{C a p} [ n ] = {τ}_{3} \times {T}_{Inv} [ n - 1 ] + ( 1 - {τ}_{3} ) \times {T}_{c a p} [ n - 1 ] + \frac{{T}_{S} [ n - 1 ]}{{C}_{Inv}} \times CapLoss \qquad ( 2 )$$

in which:
T_{Cap} is the temperature of the DC link capacitor 304 (node 400a in the electro-thermal model 400);
T_{Inv} is the average temperature within the housing 300 (node 400b);
T_{Micro} is the temperature of the microprocessor (node 400c);
T_{S} is an estimated ambient temperature derived from T_{Micro};
InvLoss is parasitic losses of components of the power electronics 114 other than the microprocessor 312 (current source 406);
CapLoss is parasitic losses within the DC link capacitor 304 (current source 410);
C_{Cap} is the capacitance (i.e., thermal analog to capacitance) of the DC link capacitor (capacitor 408);
C_{Inv} is the capacitance (i.e., thermal analog to capacitance) of the power electronics 114 other than the DC link capacitor 304 and microprocessor 312 (capacitor 404); and
τ₁, τ₂, and τ₃ are time constants.

In some embodiments, τ₁, τ₂, and τ₃ may be estimated according to equations (3), (4), and (5), where R_{Cap2Inv} is the resistance (i.e., thermal analog of resistance) of the resistor 412 and R_{Inv2Micro} is the resistance (i.e., thermal analog of resistance) of the resistor 414.

$${τ}_{1} = \frac{{T}_{S}}{{C}_{Inv} \times {R}_{Cap 2 Inv}} \qquad ( 3 )$$

$${τ}_{2} = \frac{{T}_{S}}{{C}_{Inv} \times {R}_{Inv 2 Micro}} \qquad ( 4 )$$

$${τ}_{3} = \frac{{T}_{S}}{{C}_{C a p} \times {R}_{Cap 2 Inv}} \qquad ( 5 )$$

The values of R_{Cap2Inv} and R_{Inv2Micro} may be determined experimentally. For example, temperature sensors may be mounted within the housing 300 and directly to the DC link capacitor 304. Under a variety of operating conditions, e.g., parasitic losses InvLoss and CapLoss, values for T_{Cap} and T_{Inv} may be measured using the temperature sensors along with reading the value T_{Micro} from the microprocessor 312. The values of R_{Cap2Inv}, R_{Inv2Micro}, C_{Cap}, and C_{Inv} may then be selected to reduce a difference between predicted values of T_{Cap} and T_{Inv} and the measured values for T_{Cap} and T_{Inv}. For example, R_{Cap2Inv} and R_{Inv2Micro} may be selected using logistic regression, Nelder-Mead simplex method, conjugate descent, or other numerical technique.

T_{S} may be derived from the output of the temperature sensor 314 of the microprocessor 312, T_{Micro}. In particular, the temperature measured by the temperature sensor 314 is a function of the amount of power consumed by the microprocessor 312 and the ambient temperature of the microprocessor 312. The power consumption of the microprocessor is known as being either (a) constant or (b) a function of a current operating state of the microprocessor. Accordingly, the ambient temperature of the microprocessor, T_{S}, may be derived from a known relationship between the output of the temperature sensor and the known power consumption. This relationship may be determined experimentally by operating the microprocessor 312 (e.g., a microprocessor 312 having the same design) at a plurality of ambient temperatures and reading the output of the temperature sensor 314 for each ambient temperature. A function relating the ambient temperature to the output of the temperature sensor 314 may then be generated, such as by using polynomial curve fitting or other technique. The function may be a transfer function that uses variation of T_{Micro} over time to determine T_{S}, e.g., uses a series of multiple samples of T_{Micro} to determine a current value for T_{S}.

The value of CapLoss may be calculated according to equations (6) and (7), where Iₚₕ is the magnitude of the phase current output by, or input to, the power electronics 114, M is the modulation index of the phase current (a metric corresponding to power torque output of the motor 302), ϕ is the phase of the phase current, I_{C,RMS} is the root mean square (RMS) current through the DC link capacitor 304, and R_{ESR} is the resistance of the DC link capacitor 304.

$${I}_{C , RM S} = 1.5 {I}_{p h} \sqrt{2 M ( \frac{\sqrt{3}}{4 π} + {cos}^{2} ϕ ( \frac{\sqrt{3}}{π} - \frac{9}{16} M ) )} \qquad ( 6 )$$

$$CapLoss = {R}_{E S R} {I}_{C , R MS}^{2} \qquad ( 7 )$$

At step 508, the current temperature of the DC link capacitor 304 may be estimated. For example, the values of T_{Cap} and Tᵢₙᵥ for the current time step n may be estimated according to equations (8) and (9), where the index n−1 indicates values computed for a previous time step n−1.

$${T}_{C a p} [ n ] = Δ t \times {\dot{T}}_{C a p} [ n ] + {T}_{C a p} [ n - 1 ] \qquad ( 8 )$$

$${T}_{i n v} [ n ] = Δ t \times {\dot{T}}_{i n v} [ n - 1 ] + {T}_{i n v} [ n - 1 ] \qquad ( 9 )$$

Once obtained, the values of T_{Cap} and Tᵢₙᵥ may be used for various purposes. The values of T_{Cap} and Tᵢₙᵥ may be used as feedback to reduce power input to the motor 302 to avoid failure. For example, at step 510, the values of T_{Cap} and/or Tᵢₙᵥ may be compared to one or more threshold conditions, where a threshold condition corresponding to T_{Cap} and/or Tᵢₙᵥ is met, an ameliorating action may be performed at step 512. The threshold condition may include T_{Cap} being greater than a first temperature threshold, the temperature Tᵢₙᵥ being greater than a second temperature threshold, or both. The first and second temperature thresholds may be the same or different.

The ameliorating action of step 512 may include generating an alert for a driver of the vehicle 100, such as an audible alert, a message output on the front display 104, a flashing light, or other human-perceptible output. The ameliorating action may include reducing the amount of current passing through the power electronics 114.

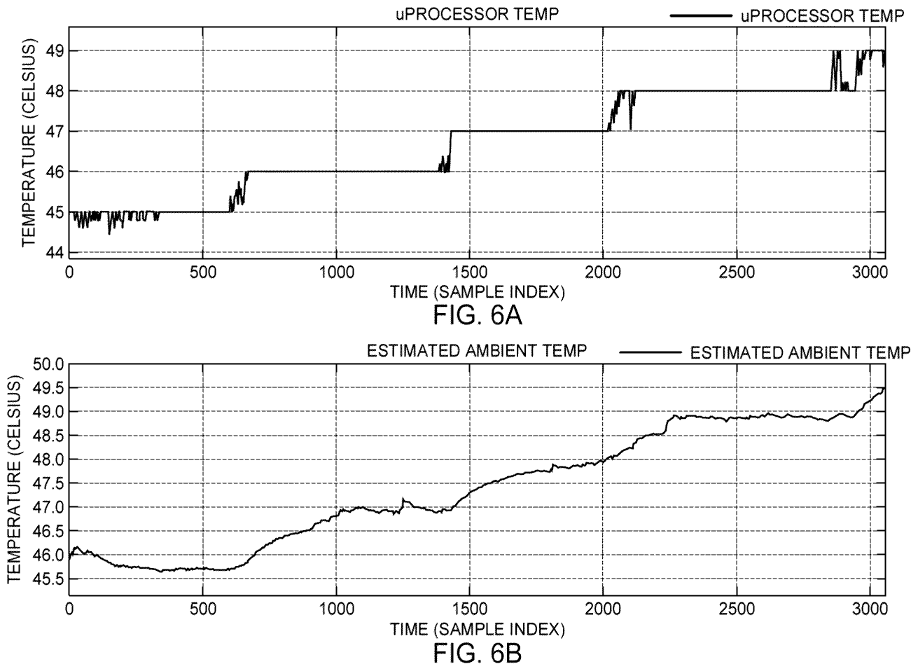

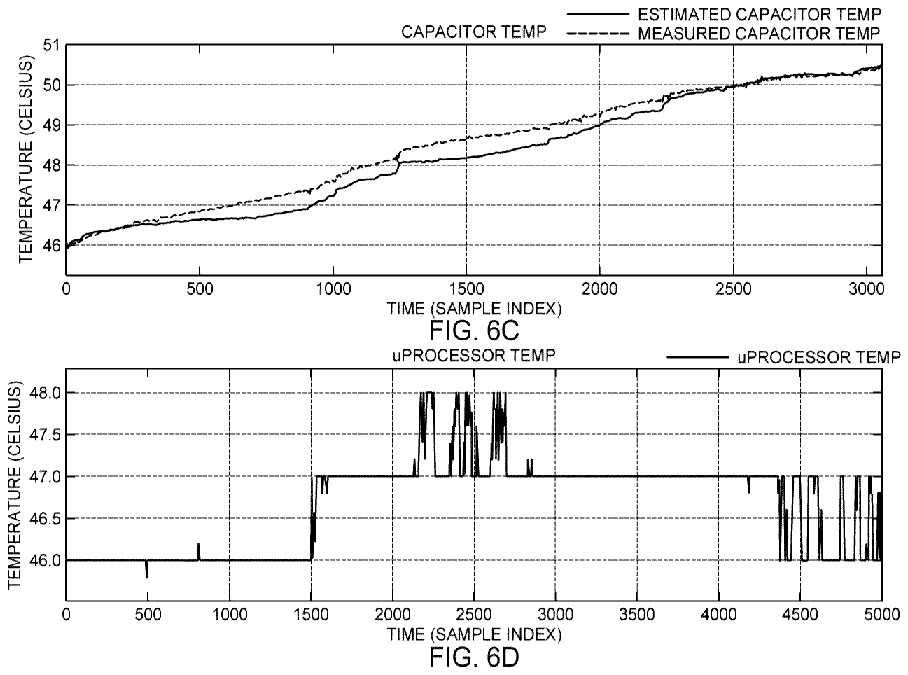

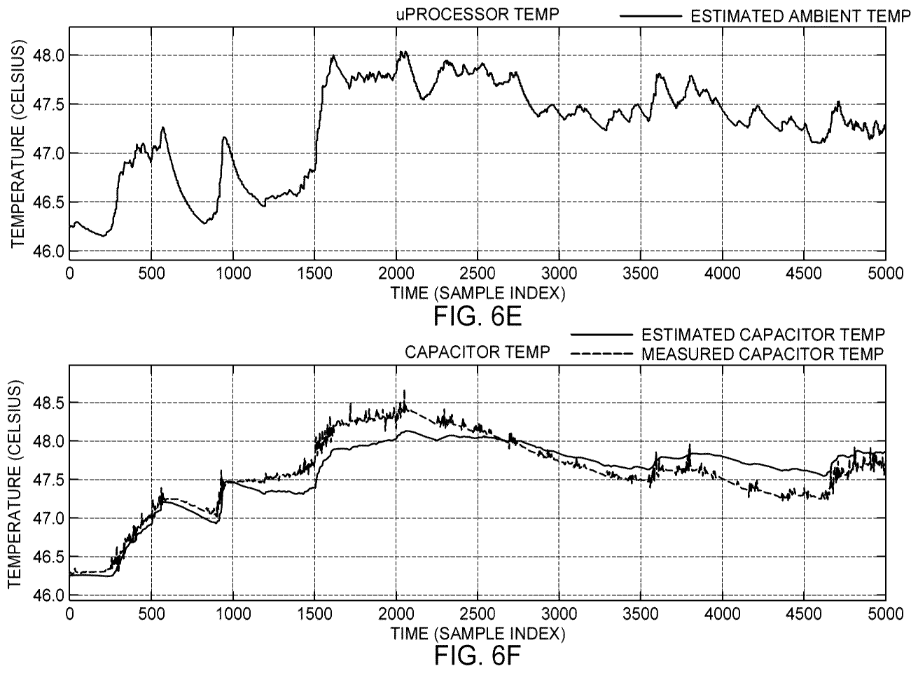

FIGS. 6A to 6F illustrate experimental results obtained using the method 500 compared to actual temperature measurements of the temperature of the DC link capacitor 304. In FIGS. 6A to 6F, the vertical axis represents temperature, and the horizontal axis represents time (e.g., sample index n). FIGS. 6A and 6D are plots of T_{Micro}. FIGS. 6B and 6E are plots of T_{S} corresponding to the plots of T_{Micro} in FIGS. 6A and 6D, respectively. FIGS. 6C and 6F are plots of measured temperature of the DC link capacitor 304 and a plot of T_{Cap} predicted according to the method 500 (“Estimated Capacitor Temp”) corresponding to the plots of T_{Micro} in FIGS. 6A and 6D, respectively. As is readily apparent, the difference between measured temperature and predicted temperature remains below 1 degree Celsius, and the predicted temperature converges to the measured temperature under steady state conditions.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

While the foregoing is directed to embodiments of the present disclosure, other and further embodiments may be devised without departing from the basic scope thereof, and the scope thereof is determined by the claims that follow.

What is claimed is:

1. An apparatus, comprising:
power electronics contained within a housing, the power electronics including circuits configured to convert direct current (DC) current to alternating current (AC) current and supply the AC current to a motor, the power electronics including a microprocessor positioned within the housing and configured to control operation of the power electronics, the microprocessor having a temperature sensor mounted directly thereto and configured to sense a temperature of the microprocessor;
a DC-link capacitor coupled to an input of the power electronics; and
a controller coupled to the microprocessor and configured to:
receive outputs of the temperature sensor;
receive one or more operational parameters of the power electronics; and
determine an estimated temperature of the DC-link capacitor based on the outputs of the temperature sensor and the one or more operational parameters of the power electronics.

2. The apparatus of claim 1, wherein the DC-link capacitor is external to the housing.

3. The apparatus of claim 1, wherein the temperature sensor is internal to the microprocessor and configured to measure a core temperature of the microprocessor.

4. The apparatus of claim 1, wherein no temperature sensor is mounted to the DC-link capacitor.

5. The apparatus of claim 1, wherein no temperature sensor is positioned within or mounted on the housing other than the temperature sensor.

6. The apparatus of claim 1, wherein the one or more operational parameters include a phase current output by the power electronics.

7. The apparatus of claim 1, wherein the one or more operational parameters include a modulation index of the power electronics.

8. The apparatus of claim 1, wherein the controller is configured to estimate the temperature of the DC-link capacitor according to an electro-thermal model.

9. The apparatus of claim 8, wherein the electro-thermal model represents the power electronics, other than the microprocessor, as a single node.

10. The apparatus of claim 9, wherein the electro-thermal model represents the microprocessor as a massless heat source.

11. The apparatus of claim 8, wherein the electro-thermal model comprises equations including:
$$\{ \begin{matrix}{\dot{T}}_{Inv} = ( 1 - {τ}_{1} ) \times {T}_{Inv} + {τ}_{1} \times {T}_{c a p} + \frac{{T}_{S}}{{C}_{Inv}} \times Inv Loss + {τ}_{1} \times ( {T}_{M i c r o} - {T}_{Inv} ) \\ {\dot{T}}_{C a p} = {τ}_{3} \times {T}_{Inv} + ( 1 - {τ}_{3} ) \times {T}_{c a p} + \frac{{T}_{S}}{{C}_{Inv}} \times Cap Loss\end{matrix}$$
where:
Tᵢₙᵥ is a temperature of the power electronics other than the microprocessor;
T_{cap} is the estimated temperature of the DC link capacitor;
T_{micro} is a temperature of the microprocessor obtained from the outputs of the temperature sensor;
T_{S} is an estimated ambient temperature based on T_{micro};
\dot{T}_{cap} is a change in temperature of the DC-link capacitor;
\dot{T}ᵢₙᵥ is a change in temperature of the power electronics other than the microprocessor;
τ₁, τ₂, and τ₃ are time constants describing heat transfer;
InvLoss is estimated resistive loss within the power electronics other than the microprocessor; and
Cap Loss is resistive loss within the DC-link capacitor.

12. The apparatus of claim 11, wherein τ₁, τ₂, and τ₃ are calculated as:
$$\{ \begin{matrix}{τ}_{1} = \frac{{T}_{s}}{{C}_{Inv} \times {R}_{Cap 2 Inv}} \\ {τ}_{2} = \frac{{T}_{s}}{{C}_{Inv} \times {R}_{Inv 2 Micro}} \\ {τ}_{3} = \frac{{T}_{s}}{{C}_{C a p} \times {R}_{Cap 2 Inv}}\end{matrix}$$
where:
Cᵢₙᵥ is a thermal capacitance of the power electronics other than the microprocessor;
C_{cap} is a thermal capacitance of the DC-link capacitor;
R_{Cap2Inv} is a thermal resistance between the DC-link capacitor and the power electronics other than the microprocessor; and
R_{Inv2Micro} is a thermal resistance between the microprocessor and the power electronics other than the microprocessor.

13. A method comprising:
transmitting direct current (DC) electrical current from a battery to power electronics by way of a DC-link capacitor, the power electronics being mounted within a housing and including a microprocessor configured to control operation of the power electronics, a temperature sensor being mounted directly to the microprocessor and configured to sense a temperature of the microprocessor;
receiving, by a controller, a temperature measurement from the temperature sensor; and
estimating, by the controller, a temperature of the DC-link capacitor based on the temperature measurement and one or more operational parameters describing operation of the power electronics.

14. The method of claim 13, wherein the temperature sensor is internal to the microprocessor and configured to sense a core temperature of the microprocessor.

15. The method of claim 13, wherein no temperature sensor is positioned within or mounted on the housing other than the temperature sensor.

16. The method of claim 13, wherein the one or more operational parameters include a phase current passing through the power electronics and a modulation index of the power electronics.

17. The method of claim 13, wherein estimating the temperature of the DC-link capacitor comprises processing an electro-thermal model.

18. The method of claim 17, wherein the electro-thermal model represents the power electronics other than the microprocessor, as a single node and represents the microprocessor as a massless heat source.

19. The method of claim 18, wherein the electro-thermal model comprises equations including:
$$\{ \begin{matrix}{\dot{T}}_{Inv} = ( 1 - {τ}_{1} ) \times {T}_{Inv} + {τ}_{1} \times {T}_{c a p} + \frac{{T}_{S}}{{C}_{Inv}} \times Inv Loss + {τ}_{1} \times ( {T}_{M i c r o} - {T}_{Inv} ) \\ {\dot{T}}_{C a p} = {τ}_{3} \times {T}_{Inv} + ( 1 - {τ}_{3} ) \times {T}_{c a p} + \frac{{T}_{S}}{{C}_{Inv}} \times Cap Loss\end{matrix}$$
where:
Tᵢₙᵥ is the temperature of the power electronics other than the microprocessor;
T_{cap} is the temperature of the power electronics other than the microprocessor;
T_{micro} is the temperature of the microprocessor;
T_{S} is an estimated ambient temperature based on T_{micro};
\dot{T}_{cap} is a change in temperature of the DC-link capacitor;
\dot{T}ᵢₙᵥ is a change in temperature of the power electronics other than the microprocessor;
τ₁, τ₂, and τ₃ are time constants describing heat transfer;
InvLoss is estimated resistive loss within the power electronics other than the microprocessor; and
Cap Loss is resistive loss within the DC-link capacitor.

20. The method of claim 19, wherein τ₁, τ₂, and τ₃ are calculated as:
$$\{ \begin{matrix}{τ}_{1} = \frac{{T}_{s}}{{C}_{Inv} \times {R}_{Cap 2 Inv}} \\ {τ}_{2} = \frac{{T}_{s}}{{C}_{Inv} \times {R}_{Inv 2 Micro}} \\ {τ}_{3} = \frac{{T}_{s}}{{C}_{C a p} \times {R}_{Cap 2 Inv}}\end{matrix}$$
where:
Cᵢₙᵥ is thermal capacitance of the power electronics other than the microprocessor;
C_{cap} is a thermal capacitance of the DC-link capacitor;
R_{Cap2Inv} is a thermal resistance between the DC-link capacitor and the power electronics other than the microprocessor; and
R_{Inv2Micro} is thermal resistance between the processor and the power electronics other than the microprocessor.
